(19) United States
(12) Patent Application Publication
(10) Pub. No.: US 2008/0135371 A1
(43) Pub. Date: Jun. 12, 2008

(54) SENSOR ASSEMBLY FOR A CLUTCH DEVICE AND A CLUTCH DEVICE WITH SUCH A SENSOR ASSEMBLY

(75) Inventors: Frank GESSLER, Grunkraut (DE); Kim Fuhrer, Lindau (DE); Thomas Puth, Friedrichshafen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/941,297

(22) Filed: Nov. 16, 2007

(30) Foreign Application Priority Data
Nov. 18, 2006 (DE) 10 2006 054 401.3

(51) Int. Cl. F16D 48/06

(52) U.S. Cl. 192/30 W

(57) ABSTRACT

A sensor assembly (1) for a clutch device with a separate sensor component (8), comprising a mounting section (9) for affixing the sensor component to a stationary section (2), a sensor (11) for measuring on a movable component (5) and one signal line (15,16) that is connected to the sensor and to a connecting section (14) of the sensor component (8), in order to connect the signal line to a stationary device (7). The sensor component is configured in such a way that the mounting section and the connecting section are arranged in a permanent alignment in relation to each other so that the connection section is automatically connected to the stationary device when the fixing device is fixed to the stationary section. The present invention also relates to a clutch device with this kind of sensor assembly.

The invention relates to a sensor assembly for a clutch device with a separate sensor component, which features a mounting section for mounting the sensor component to a stationary section; a sensor for measuring a movable section, and at least one signal line that is connected to the sensor and a connecting section of the sensor component for connecting the signal line to a stationary device. The invention also relates to a clutch device with this kind of sensor assembly.

Various sensor assemblies are known from the state of the art, which primarily serve to detect a path or a position. DE 103 51 993 A1 describes an actuator for a vehicle clutch with a path sensor. In order to detect the path of the clutch, a part is provided on a piston of the clutch actuator that protrudes radially outward. The path, followed by a piston or a radially protruding part, which also corresponds to the clutch path, is transferred, via a sheathed cable or a Bowden cable, to the sensor. From the sensor, a corresponding signal line leads to a signal-processing unit that is not described in detail.

Another sensor assembly for a clutch device is known from DE 10 2004 003 287 A1. The known sensor assembly comprises a sensor deposed on the clutch bell through which two light conductors pass, whose ends are aligned with the external teeth of an intermediate plate of a double clutch. A light signal is applied to the external teeth via a light conductor, where the reflected light is detected and relayed by the other light conductor or by its end. A flexible cable is attached to the sensor in which both light conductors are bundled, and which leads to a unit of the transmission or the clutch, which is not described in detail.

The known sensor assemblies are characterized by the disadvantage that their installation on the transmission or the clutch is difficult and complex. In addition, the known solutions do not always guarantee a secure connection between the sensor component and/or the signal-processing unit.

The invention therefore has the task of devising a sensor assembly for a clutch device that can be simply and securely installed and guarantee a secure connection between the sensor and signal-processing unit. The invention also has the task of devising a clutch device with this kind of advantageous sensor assembly.

These tasks are resolved by way of the features shown in patent claim 1, or as the case may be, 13. Advantageous embodiments of the invention are the subject of the sub-claims.

The inventive sensor assembly for a clutch device, such as a clutch device for a motor vehicle features, first, a separate sensor assembly. The sensor assembly comprises a mounting section for mounting the assembly to a stationary section, where the stationary section can comprise of the housing of the clutch device or a housing of an adjacent transmission The sensor assembly also features a sensor for measuring a movable section, where the movable section can be the release cylinder or the clutch device. The sensor assembly also comprises a signal line that is connected with the sensor and with a connecting section of the sensor assembly, where the connecting section of the sensor assembly serves the purpose of connecting the signal line to a stationary device. The stationary device can be a signal-processing unit. Inventively, the sensor assembly is configured in such a way that the mounting section and the connecting section are placed in a permanent arrangement, relative to each other, so that the mounting section is automatically connected with the stationary section, when the mounting section is attached to the stationary section.

Thanks to the secure arrangement of the mounting section relative to the connecting section, it is assured that when the sensor component is installed, the signal line is securely connected to the corresponding stationary device. This also eliminates one assembly step, as it is no longer necessary to connect a plug or the like to the signal-processing unit once the sensor component or its mounting section has been mounted to the stationary section.

In a preferred embodiment of the inventive sensor assembly, the sensor component is at least partially configured as mounted, so that the mounting section and the connecting section are aligned in a secure arrangement.

In principle, the mounting section and the connecting section can be made up of the same section of the sensor component. However, in order to establish a stable sensor assembly that bridges a long path to the stationary device, it has proved advantageous to have the mounting section and the connecting section made up of different sections of the sensor component. In a further preferred embodiment of the inventive sensor assembly, the mounting section and the connecting section are made up of sections of the sensor component that are located at a distance from each other and between which a bridging section extends. The mounting section, the connecting section and the bridging section are hereby fixed in place in order to guarantee the same arrangement relative to each other.

A further problem connected with the known sensor assemblys is the fact that the exposed cable, which runs from the sensor to a stationary device, is exposed to internal influences and is therefore vulnerable to damage. In order to largely exclude the possibility of damage to the signal line, the signal line is placed, in a particularly advantageous embodiment of the inventive sensor assembly, within the sensor component and/or as adjacent the sensor component.

In an advantageous embodiment of the inventive sensor assembly, the mounting stationary section features a mounting section onto which the mounting section of the sensor component can be fixed and the stationary decive features a connecting section that can be connected to the connecting section of the sensor component, where the mounting section of the stationary section and the connecting section of the stationary device are aligned in a constant arrangement relative to each other. In order to guarantee a secure mounting of the sensor component and a secure connection of the signal line, this constant arrangement should correspond to the secure arrangement that is already known from the sensor component.

In a further advantageous embodiment of the inventive sensor assembly, the mounting section of the sensor component and the mounting section of the stationary section are configured so that when the sensor component is installed, the mounting section of the sensor component is first passed through the mounting section of the stationary section and then the connection is created, between the connecting section of the sensor component and the connecting section of the stationary device.

According to one particularly advantageous embodiment of the inventive sensor assembly, the mounting sections, i.e., the mounting section on the sensor component and/or the mounting section on the stationary section are configured in such a way that they can only be secured to each other in a predetermined arrangement. In this way, it is assured that the connecting section of the sensor component is also actually connected to the connection section of the stationary device, when the sensor component is fixed to the stationary section.

In another advantageous embodiment of the inventive sensor assembly, the connecting sections form a connection assembly in which the connecting sections can be inserted one into the other. For example, the connecting section on the sensor component can be configured as a plug or a jack, whereas the connecting section on the stationary device can be configured as a jack or a plug. By way of the appropriate configuration of plug and jack, potential manufacturing tolerances can be overcome.

In another advantageous embodiment of the inventive sensor assembly, a guide component is also provided for a corresponding element assigned to the sensor, the corresponding element is arranged on the movable section, where the guide component is arranged independently of the sensor component on a stationary section. The corresponding element is understood as a part on which the sensor taps its signals. Due to the separation of the guide component and the sensor component, it is guaranteed that the vibrations and the like acting on the guide component are not transmitted to the sensor component or to the sensor. In this way, more accurate detection is achieved.

In another advantageous embodiment of the inventive sensor assembly, the sensor is configured as a position sensor for detecting the position of the clutch.

According to an additional advantageous embodiment of the inventive sensor assembly, the stationary section is configured as part of the clutch device or an adjacent device, preferably as a housing of the clutch device or an adjacent transmission.

In an additional advantageous embodiment of the inventive sensor assembly, the movable section is an axially displaceable release cylinder of the clutch device. The term “axially” refers here to the axis of the clutch device.

In another advantageous embodiment of the inventive sensor assembly, the stationary device is an electronic controller, which can be used for controlling the transmission and/or the clutch.

The inventive clutch device, for example a clutch device in a motor vehicle, features a sensor assembly of the inventive type described above.

The invention will be explained below on the basis of an exemplary embodiment with reference to the appropriate drawings. They show:

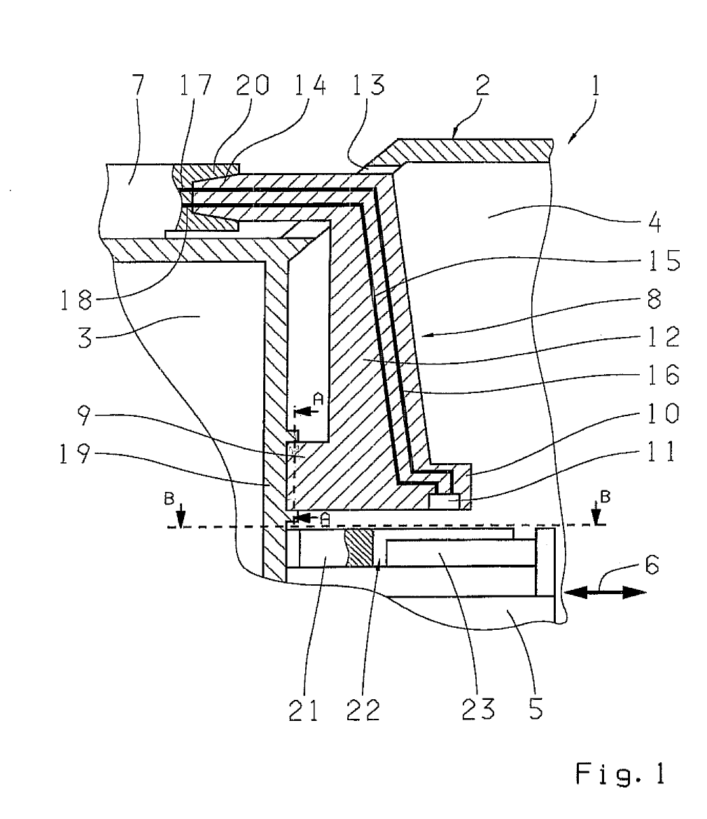

FIG. 1 is a lateral view of an embodiment of the inventive sensor assembly for a clutch device in partial cross-sectional view;

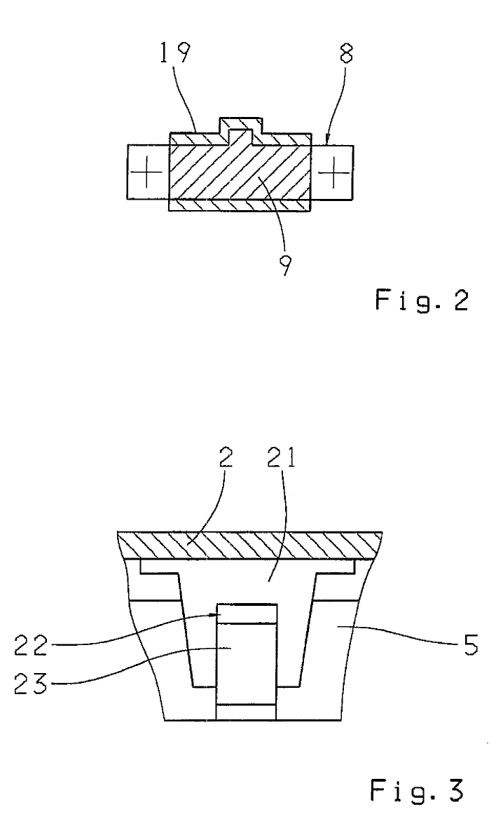

FIG. 2 is a top view of the section line A-A of FIG. 1, and

FIG. 3 is a top view of the section line B-B of FIG. 1.

FIG. 1 shows an embodiment of the inventive sensor assembly 1. The sensor assembly 1 is situated on a transmission/clutch housing 2, which surrounds, on the one hand, a gear chamber 3 and, on the other, a clutch compartment 4. The transmission/clutch compartment 2 is configured as a stationary section relative to the other parts of the transmission or clutch. The clutch features a release cylinder 5 that can be displaced in the direction of an arrow 6, i.e., namely in an axial direction, opposite the transmission/clutch housing 2. The release cylinder 5 is therefore configured as a movable section. On the external side of the transmission/clutch housing 2, another stationary device is provided in the form of an electronic controller 7 for controlling the transmission and/or clutch.

The sensor assembly 1 comprises a separate sensor component 8, which is made of plastic and comprises a plurality of sections. The sensor component 8 thus features a mounting section 9 for fixing the sensor component 8 to the transmission/clutch housing 2. In addition, the sensor component 8 also comprises a sensor section 10 in which a sensor 11 for measurement is arranged on the movable section in the form of the release cylinder 5. The sensor section 10 is arranged in the immediate vicinity of the mounting section 9 and is continuous with a bridging section 12 that extends radially outward. In the installed state of the sensor component 8, the bridging section 12 extends outward through an opening 13 in the transmission/clutch housing 2 and is continuous with a connecting section 14 of the sensor component 8, which serves to connect the sensor component 8 to the stationary device in the form of an electronic controller 7.

Two signal lines 15, 16 are arranged inside the sensor component 8. The signal lines 15, 16 are connected to the sensor 11 and extend through the sensor section 10 and the bridge section 12 to the connecting section 14, where they can be connected to signal lines 17, 18 of the electronic controller 7. The signal lines 15,16 can, in principle, also be arranged externally adjacent to the sensor component 8, where the internal arrangement ensures more secure transmission as well as less danger of damage.

As can be seen from FIG. 1, which shows an installed sensor component 8 configured in such a way that the mounting section 9 and the connecting section 14 are placed in a secure arrangement, relative to each other, so that the connecting section 14 is automatically connected to the electronic controller 7 when the mounting section 9 is fixed to the transmission/clutch compartment 2. In the present embodiment, this is achieved by a fixed arrangement of the sensor component 8 in the mounting section 9, the bridging section 12 and the connecting section 14. In the present example, the sensor component 8 is also completely fixed, which means that the sensor section 10 is also fixed. As FIG. 1 also shows, the mounting section 9 and the connecting section 14 are formed of sections of the sensor component 8 that are located at a distance from each other. This is an advantage in that the mounting section 9 can be positioned closer to the sensor section 10 in order to hold it in place, whereas the connecting section 14 can be moved far in a radially outward direction toward the electronic controller 7.

In order to ensure the sensor component 8 is securely arranged on the device, the transmission/clutch compartment 2 also features a mounting section 19, to which the mounting section 9 of the sensor component 8 can be fixed. In addition, the electronic controller 7 features a connecting section 20 which can be connected to the connecting section 14 of the sensor component 8. In order to ensure that by mounting the mounting sections 9, 19 alone, a secure connection will be established between the signal lines 15, 16 or 17, 18, the mounting section 19 of the transmission/clutch compartment 2 and the connecting section 20 of the electronic controller 7 are also arranged in a secure alignment to each other, that corresponds to the arrangement of the mounting section 9 of the sensor component 8 relative to the connecting section 14 of the sensor component 8.

As can be seen from FIG. 2, which shows a top view of the section line A-A of FIG. 1, the mounting sections 9, 19 are configured in such a way that they can only be affixed to each other in a predetermined arrangement. In cross-section, the mounting section 9 therefore has an upside-down T-shaped contour, whereas the mounting section 19 has a corresponding upside-down T-shaped recess. In that way, the sensor component 8 can only be anchored in the arrangement shown in FIG. 1. It can also be seen from FIG. 2 that there is also a flange arranged on the mounting section 9 of the sensor component 8, which makes it possible to screw the sensor component 8 and the transmission/clutch housing 2 together. The connecting sections 14, 20 are coordinated in such a way that they comprise a connection assembly. For this purpose, the connecting section 14 is configured as a conical plug which can be inserted into a conically-shaped impression connecting section 20.

The sensor assembly 1 also features a guide component 21 which, in the top view shown in FIG. 3 is essentially U-shaped. Between the two legs of the guide component 21, a channel 22 is provided in which a counterpiece associated with sensor 11 is inserted. A counterpiece 23 is provided on the release cylinder 5 of the clutch and can therefore be moved with the release cylinder in the direction of the arrow 6 within the channel 22. On the side of the sensor 11, facing the counterpiece 23, markings or the like can be provided which the sensor 11 can detect in order to reach conclusions about the position of the release cylinder 5 in an axial direction 6. The sensor 11 is a position sensor for detecting the clutch position, whereby the sensor 11 can be any suitable sensor, such as an optical capacitive or inductive sensor.

The guide component 21 is arranged independently of the sensor component 8 on the transmission/clutch housing 2 at a distance from the sensor component 8. This has the advantage that when vibrations act on the guide component 21, via the release cylinder 5 and the counterpiece 23, they are not transmitted to the sensor component 8 where they could interfere with measurement.

### REFERENCE SIGNS

1 sensor assembly

2 transmission/clutch housing

3 gear chamber

4 clutch compartment

5 release cylinder

6 arrow

7 electronic controller

8 sensor component

9 mounting section (signal section)

10 sensor section

11 sensor

12 bridging section

13 opening

14 connecting section (signal section)

15 signal line (sensor component)

16 signal line (sensor component)

17 signal line (electronic controller)

18 signal line (electronic controller)

19 mounting section (transmission/clutch housing)

20 connecting section (electronic controller)

21 guide component

22 channel

23 counterpiece

1-14. (canceled)

15. A sensor assembly (1) for a clutch device with a separate sensor component (8), the sensor assembly comprising a mounting section (9) for securing the sensor component (8) to a stationary section (2), a sensor (11) for measuring movement of a movable section (5) and at least one signal line (15, 16), the sensor (11) being connected to a connecting section (14) of the sensor component (8) for connecting the at least one signal line (15, 16) to a stationary device (7), the sensor component (8) being designed such that the mounting section (9) and the connecting section (14) remain arranged in a same alignment with respect to one another such that the connecting section (14) is automatically connected to the stationary device (7) when the mounting section (9) is secured to the stationary section (2).

16. The sensor assembly according to claim 15, wherein the sensor component (8) is at least partially secured in place so that the mounting section (9) and the connecting section (14) remain arranged in the same alignment with respect to one another.

17. The sensor assembly according to claim 15, wherein the mounting section (9) and the connecting section (14) are sections of the sensor component (8) that are spaced from one another between which a bridging component (12) extends.

18. The sensor assembly according to claim 15, wherein the at least one signal line (15, 16), between the sensor (11) and the connecting section (14), is at least one of arranged inside the sensor component (8) and adjacent the sensor component (8).

19. The sensor assembly according to claim 15, wherein the stationary section (2) has a mounting section (19) onto which the mounting section (9) of the sensor component (8) is secured, and the stationary device (7) has a connecting section (20) that is connected to the sensor component (8), the mounting section (19) of the stationary section (2) and the connecting section (20) of the stationary device (7) are arranged in a permanent alignment with respect to one another.

20. The sensor assembly according to claim 19, wherein the mounting section (9) of the sensor component (8) is first attached to the mounting section (19) of the stationary section (2), and subsequently the connection between the connecting section (14) of the sensor component (8) and the connecting section (20) of the stationary device (7) is established.

21. The sensor assembly according to claim 19, wherein the mounting section (9) of the sensor component (8) and the mounting section (19) of the stationary section (20) are designed such that these sections are only connected in a predefined arrangement.

22. The sensor assembly according to claim 19, wherein the connecting section (14) of the sensor component (8) and the connecting section (20) of the stationary device (7) form a connection assembly in which one section can be inserted into the other section.

23. The sensor assembly according to claim 15, wherein a guide component (21) for a corresponding element (23) assigned to the sensor (11) is provided on the movable section (5), the guide component (21) is arranged independently of the sensor component (8) on the stationary section (2).

24. The sensor assembly according to claim 15, wherein the sensor (11) is a position sensor for detecting a position of the clutch device.

25. The sensor assembly according to claim 15, wherein the stationary section (2) is one of a part of the clutch device, a housing of the clutch device and an adjacent transmission housing.

26. The sensor assembly according to claim 15, wherein the movable section (5) is an axially displaceable release cylinder (5) of the clutch device.

27. The sensor assembly according to claim 15, wherein the stationary device (7) is an electronic controller.

28. A clutch device and a sensor assembly (1) having a separate sensor component (8), the sensor assembly comprising a mounting section (9) for securing the sensor component (8) to a stationary section (2), a sensor (11) for measuring movement of a movable section (5) and at least one signal line (15, 16), the sensor (11) being connected to a connecting section (14) of the sensor component (8) for connecting the at least one signal line (15, 16) to a stationary device (7), the sensor component (8) being designed such that the mounting section (9) and the connecting section (14) remain arranged in a same alignment with respect to one another such that the connecting section (14) is automatically connected to the stationary device (7) when the mounting section (9) is secured to the stationary section (2).

29. A sensor assembly (1) for measuring movement and a position of a clutch, the sensor assembly (1) comprising:
a sensor component (8) having a connecting section (14), a bridging section (12), a mounting section (9) and a sensor section (10), the mounting section (9) and the sensor section (10) being located at a first end of the bridging section (12) and the connecting section (14) being located on a second end of the bridging section (12);
the mounting section (9) of the sensor component (8) mating with a mounting section (19) of a housing (2) for rigidly securing the sensor component (8) to the housing (2);
a sensor (11) being secured to the sensor section (10) of the sensor component (8) adjacent a slidable portion of the clutch;
at least one signal line (15, 16) being connected to the sensor (11) and extending from the sensor section (10) of the sensor component (8) through the bridging section (12) of the sensor component (8) to the connecting section (14) of the sensor component (8); and
a contour of the mounting section (9) of the sensor component (8) mating with a contour of a mounting section (1 9) of the housing (2), such that the at least one signal line (15, 16) at the connecting section (14) of the sensor component (8) aligns and communicates with at least one signal line (17, 18) of a stationary device (7) which fixed to the housing (2).
